(19) United States
(12) Patent Application Publication
(10) Pub. No.: US 2006/0149648 A1
(43) Pub. Date: Jul. 6, 2006

(54) Promoting products or services using custom software to deliver

(76) Inventor: Collie D. Brown, Mount Vernon, NY (US)

Correspondence Address: COLLIE D. BROWN, 206 North Columbus Ave, Mount Vernon, NY, 10552, US

(21) Appl. No.: 11/028,397

(22) Filed: Jan. 3, 2005

(51) Int. Cl. G06Q 40/00

(52) U.S. Cl. 705/35

(57) ABSTRACT

A means for companies to promote products or services to their customers, the general public or any group of users it provides its software to. This invention is particularly useful to financial and marketing companies to allow them to create private channels through which they can market their products or services to the software users.

### CROSS-REFERENCE TO RELATED APPLICATIONS

Not applicable.

### BACKGROUND—FIELD OF INVENTION

This invention relates to using electronic money management software as a means for companies offering financial products or services to communicate marketing messages to users of software it provides while protecting the user's privacy

### BACKGROUND OF THE INVENTION

Today companies that offer financial products or services to their customers and consumers rely on traditional means such as sending direct mail via the postal service, emails and advertising in publications and on electronic media such as radio and television. These traditional means target a mass audience and are therefore as general as possible in order to appeal to as many people as possible. By appealing to a mass audience most recipients of such appeals will not see the benefit of the product or service as applying to them, and will therefore ignore such appeals. When such appeals are sent via postal mail or by emails most are viewed as junk mail and are discarded without much investigation.

Repeated direct marketing campaigns when targeted at the same group of customers or consumers quickly become a nuisance to these recipients. Campaigns using direct postal mail require advanced planning and preparation (long lead times). When electronic media such as radio and television are used in such campaigns, additional planning and expense are required to account for the differences in each media market.

With the advent of ecommerce, emails have emerged as an advertising medium; it is low cost and easy to produce. These two good traits, low cost and ease of production have resulted in wholesale abuse. Billions of email solicitations have been produced advertisings every thing from Viagra to pansy schemes. The share number and content of these email solicitations have resulted in governments proposing or enacting laws to try to regulate this form of advertising. A new software filtering industry has sprung up to try to reduce the email onslaught on consumers email inboxes. The onslaught of emails on consumers has resulted in most email advertisements (solicitations) being viewed as undesirable junk mail or spam thereby reducing the likelihood of these solicitation achieving their intended goal which is to get the consumers or customers to act on the information contained in the solicitations.

Another abuse of email as a medium to advertise new products or services to customers is the advent of Phishing. (Email is sent to customers; especially those of financial institutions requesting the customer confirm or enter confidential information, usually but not limited to the customer's accounts. Such emails are usually authentic looking and are often times very difficult for the customer to determine that they are not sent from their financial institution.) Once the customer fills in the account information, it is used by thieves to steal their identity or to steal money from the customer's account.

This invention provides a comprehensive means for companies' particularly financial institutions to advertise new products or services to their customers and consumers, It allows financial institutions to provide targeted solicitations to their customers and consumers that are based on analyzing the customer's or consumer's information to make it as targeted and as specific as possible.

This invention require companies particularly financial institutions, to provide software to their customers or to the general public that allow the software user to manage the different types of financial accounts the user may have. These accounts may reside at one or more companies that may or may not be associated or affiliated with the company providing the software.

The software from time to time or as instructed by the software provider, will download marketing information from the software provider, affiliate or associate, do an analysis of the user's accounts, then make recommendations or sales pitches to the user based on its analysis of the user's accounts. The advantage of this marketing approach is that the software makes pitches to the user that are more meaningful, it can show the user comparisons using the marketing data it downloaded and the users account data. The comparisons are based on the user's actual information and are therefore very accurate. Only pitches that are relevant and pertinent are presented to the user.

The user's privacy is protected by downloading marketing campaigns that may or may not apply to the user thereby preventing the software provider from determining the kinds of account(s) the user may have by analyzing what marketing information is being downloaded. As mentioned above, only relevant pitches will actually be presented to the user. The user is required to act on any recommendation or solicitation the software presents to the user in order for the user's information to be sent to the company making the solicitation.

With the user's authorization the software can generate or pre-populate applications using information from the user's account and from marketing information it downloaded, thereby reducing the steps necessary to take advantage of the offer, thus making it more likely the user will accept the offer.

### SUMMARY

It is an object of this invention to allow companies to tailor the marketing of financial products or services to users of the software of this invention.

### OBJECTS AND ADVANTAGES

Accordingly, beside the objects and advantages of the marketing strategy described in the above patent application description, several objects and advantages are
a) to allow companies to provide a private channel through which to market products and services to users of its software;
b) to allow the presentation of offers made by the company to include only those offers that the software determines will be of interest to the user based on its analysis of the users account information;
c) to prevent the overexposure of the software user to marketing campaigns that are not relevant to the user;
d) to provide software that users can use to manage their financial accounts;
e) to increase the brand or name awareness of the software provider by including the name of the software provider at one or more prominent locations on the software;
f) to convey the image that the software is an extension of the software provider;

Further objects and advantages will become apparent from a consideration of the ensuing descriptions and drawings.

### DRAWINGS FIGURES

In the drawings, closely related figures have the same number but different alphabetic suffixes. Elements in each figure that are closely related also have the same number but different alphabetic suffixes.

FIG. 1 shows three methods or ways the user can be provided the software.

FIG. 2A shows the process of creating a promotion, uploading the promotion and the promotion being downloaded by the software user.

FIG. 2B shows a promotion being evaluated before being presented to the user.

FIG. 2C shows the software user taking advantage of a promotion that has been presented to the user after being evaluated by the software.

### REFERENCE NUMERALS IN DRAWINGS

10 money management software provided by a company that their customer or the general public uses to manages their financial accounts

11 the software on disk being delivered by the postal system

12 User visits the office or location designated by the software provider where the user is given disk containing software

20 software that is used to create and upload the promotions to a website where it is downloaded by the user's software

20A a created promotion or solicitation is being uploaded to a website

20B promotions from one or more promotion providers being downloaded into the users software

20C the downloaded promotion about to be evaluated by the users software.

25 the website that stores the promotion from which the user may download said promotions

26 an ID that identifies the company that provided the software to the user that is used to determine which promotions the user can download if the server stores promotions from more than one software provider or promotion creator

30 the user's account information to be used when evaluating a promotion

32 the user's software determines if the promotion should be presented to the user based on its analysis of the user's account s and the downloaded promotions

33 the software determines if a promotion analysis was triggered by the user asking to see what promotions are available

35 the software informs the user that no suitable promotion(s) are available after analyzing promotions it may have downloaded.

37 the software presents the promotion to the user after evaluating and determining that the promotion is appropriate for the user

40 the software determines if the user wants to take advantage of the promotion based on user input

41 the software determines if the promotion requires the user to provide information form the user's accounts to the company offering the promotion

42 the user is not interested in the promotion so the user's software closes the promotion and allows the user to resume normal use of the software

43 the user's software fills in as much information as it can that may be required to take advantage of the promotion and waits for the user to fill in any data it could not populate

44 the user is not required to enter any information so the software simply waits for the user to follow the promotion's instructions

### DRAWING DESCRIPTIONS

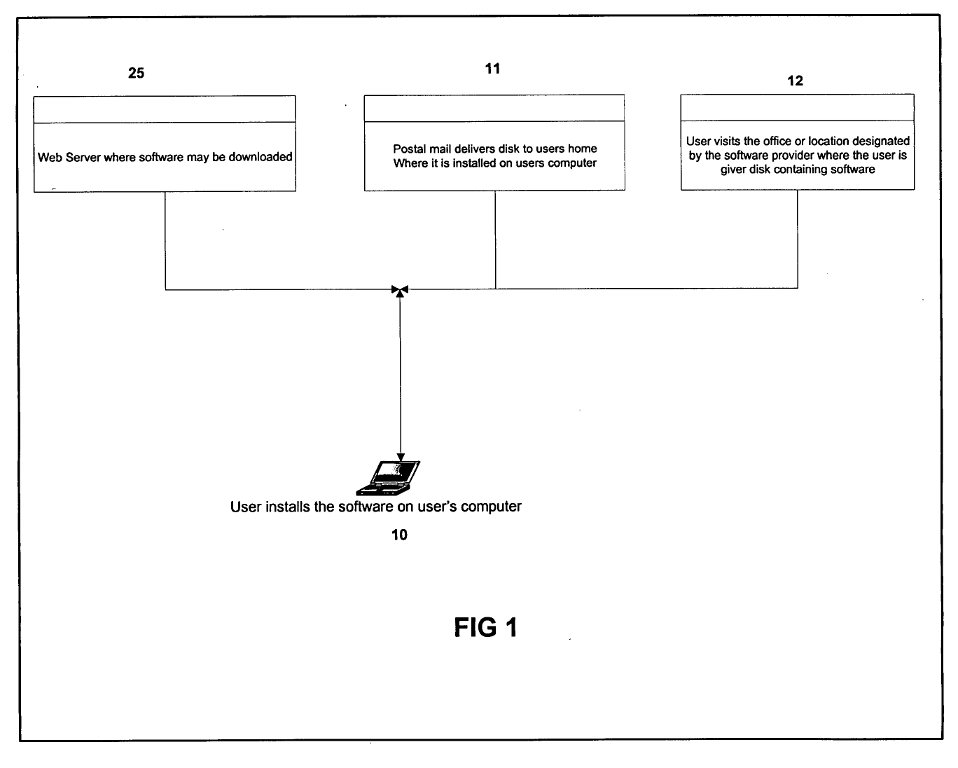

FIG. 1—Downloading Personal Finance Software—Preferred Embodiment

shows three methods that the software provider can use to distribute the software to their customer or to the general public. In implementations where the software is distributed only to the customers of the software provider, the software recipient may be required to provide information that identifies them as such before the software is made available.

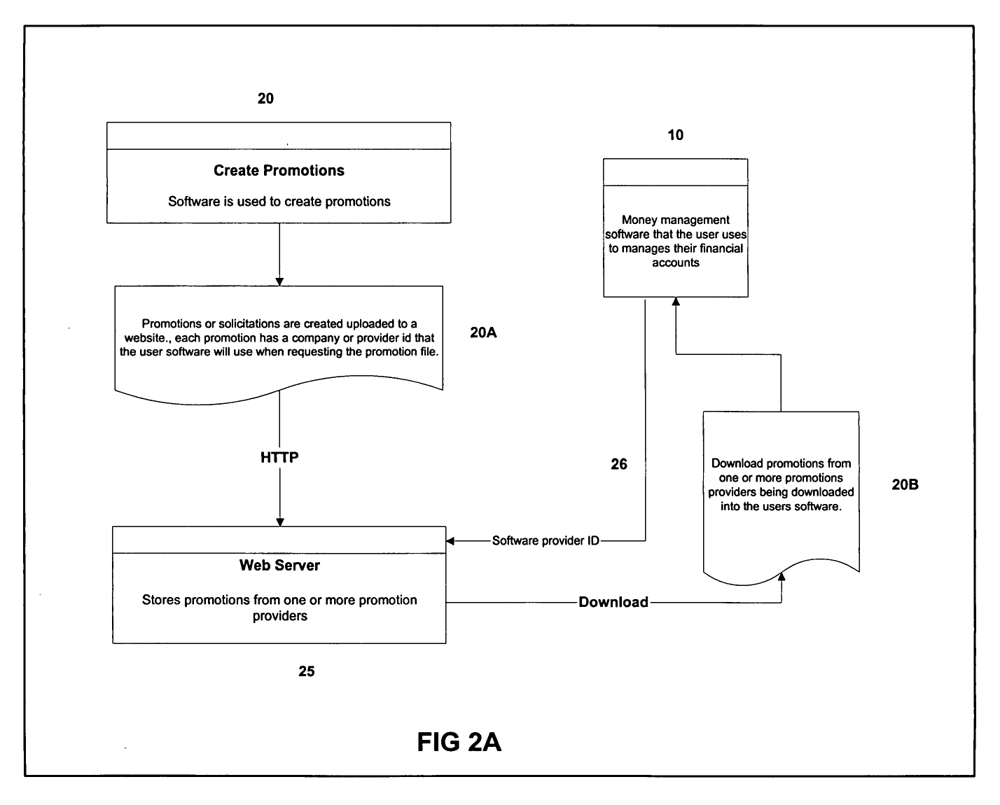

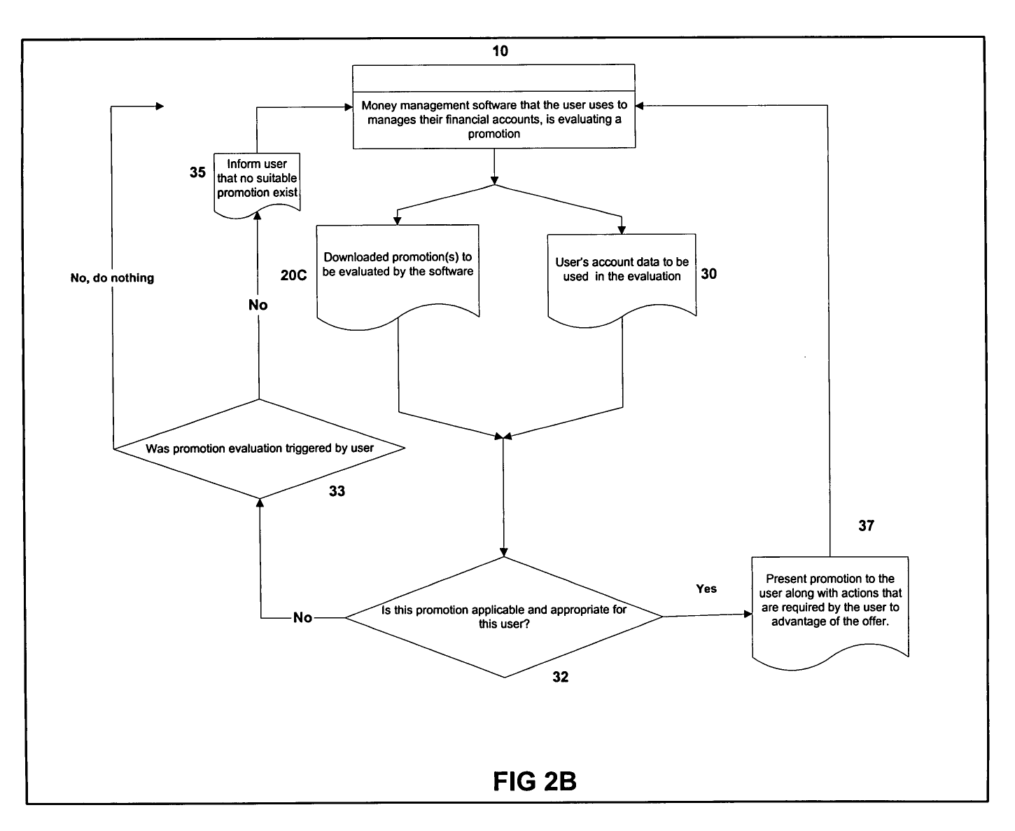

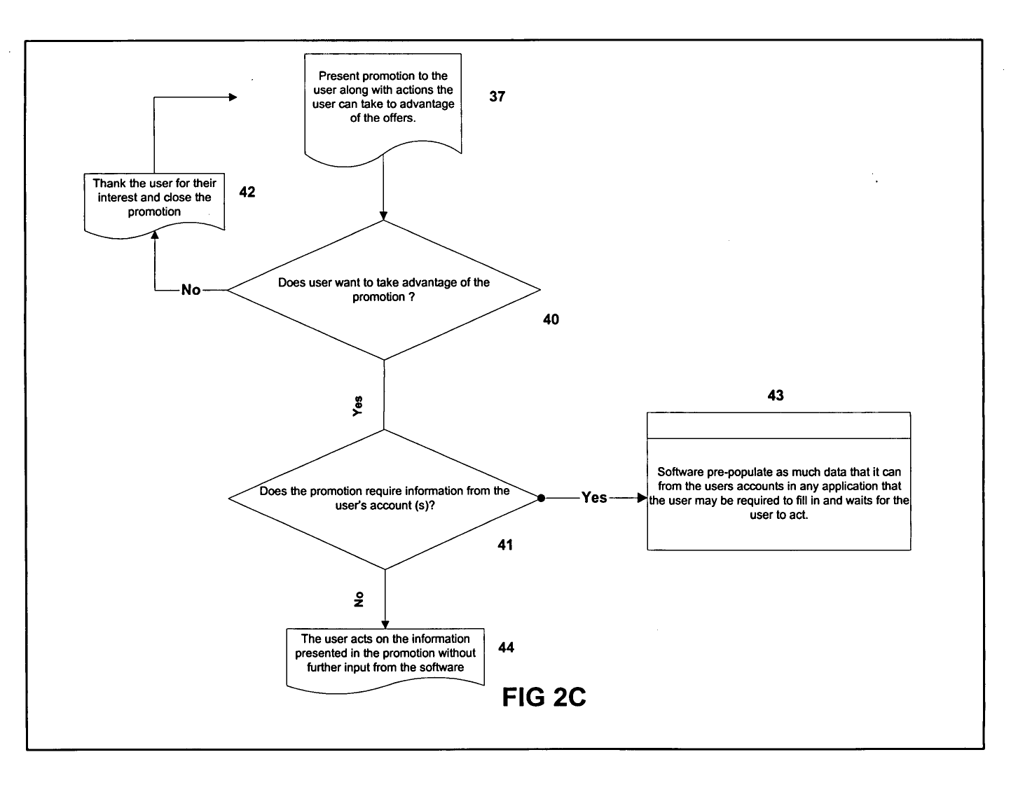

FIG. 2A—Promotions Being Created and Uploaded to a Website Preferred Embodiment

Shows the process of creating 20 and uploading promotions 20A to a website 25 where it will be downloaded by the software distributed in FIG. 1. Each promotion has an ID of the creator thereby allowing the website to store promotions from multiple promotion providers and allows the web server to distribute the correct promotions to the users' software, by evaluating the id number supplied by the users' software when it wishes to download promotions.

FIG. 2B—Evaluating a Promotion Along With the User's Account—Preferred Embodiment

Shows the user's personal finance software evaluating a promotion 20C using the user's account information 30 in the evaluation. If the software determines that the promotion is not applicable or relevant to the user, the software will inform the user that no promotions are available 35 if it was the user that triggered the promotion evaluation, otherwise it does nothing. If the user's software determines a promotion should be offered to the user, it displays the promotions to the user 37 and waits for the user's input.

FIG. 2C—The User Takes Advantage of a Promotion—Preferred Embodiment

Shows the users personal finance software displaying a promotion to the user 37. If the user is not interested in the promotion, the user can close the promotion 42 and continue using the other features of the software. If the user is interested in the promotion, the software will check to see if the promotion requires the user fill in information that may be obtained from the user's account 41. If such information is needed and is available, the software fills in or pre-populates the information for the user's account 43 thereby reducing the effort needed for the user to take advantage of promotion.

Advantages

From the description above, a number of advantages of using personal finance software to present financial promotions to the software user become evident:
(a) By providing personal finance software to their customers or to the general public, companies can create and send promotions that target any account the user may manage with the software that is held at a competing financial institution.
(b) By providing personal finance software to their customers or to the general public, companies create a private channel through which they can send promotions to the users of the software.
(c) By providing personal finance software to their customers or to the general public, companies extend their services and presence beyond the physical boundaries of their organizations while increasing brand and name recognition to the software users even when the software .?
   Operation—FIGS. 1, 2a, 2b, and 2c

This invention requires the creation and distribution of software that allows its users to manage their financial accounts that may be held at multiple financial institutions. The software is provided to company's customers or to the general public. The software allows the user to manage many types of accounts including some types of account that the company providing the software may not have or service. By providing the software to the customer, the company creates a channel through which targeted promotions and solicitations can be sent to the user. This is achieved by the software provider creating the promotion data and uploading it to a website. The software from time to time or as programmed by the software provider, downloads the promotion data.

Targeting promotions towards specific accounts such as a savings account that the user has at another financial institution may be done by creating a promotion that offers the user a higher interest rate, free check writing, etc. The user's software compares the interest rate of the user's bank account with the interest rate in the promotion, if the interest rate in the promotion offers a higher rate of return than the user is currently receiving the offer is presented to the user otherwise the offer is not shown to the user. This also allows the software provider or financial institution to not present to the user offers that the user may determine to be worse that what the user currently has, which could lead to the user viewing any offer from the promotion provider as junk solicitation to be ignored. Some companies will let the software present some or all promotional offers to the user whether or not the offer being extended is better than what the user may have, they want the user , not the software to decide if a promotion is of interest to them. As stated earlier, companies that do this runs the risk of users concluding that some or all of the promotions are nuisance (junk) solicitations to be ignored.

The software also allows the user to test and view the results or effect of various purchasing, sales and investment scenarios, before they are made. This allows the company, through the software, to participate in the user's decision making process and to make recommendations that take advantage of the products and or services the company or an affiliate offers. This is a significant advantage for the software provider, since they now have the opportunity to influence the user long before other companies get their chance to.

Conclusion, Ramifications and Scope

Accordingly, the reader will see that by providing personal finance software to their customers or to the general public:
Companies create their own private channel over which they have full marketing control and through which they can market or promote their products or services to the software user;
By leveraging this software, companies are now in a position to target their promotions at the users accounts that are not held at the software provider's company and that the company would not have otherwise know about;
By providing personal finance software to its customers, companies extend the reach and range of products and services they can offer through the software, above and beyond what the company can provide at the company's physical location(s) or online through websites;
The addition of its name and logo to the software the company distributes, helps it project a larger market presence and increases its name or brand recognition which increases the value of the company;
By providing software to its customers or the general public that include the ability to test various purchasing, sales and investment scenarios, companies, can program the software to recommend their products or services to the user while the idea is still being developed, thus giving the software provider a significant advantage over companies that may provide similar products or services the user may be considering.

1. A method for a company to use software to promote or advertise products or services to users of the software or solicit business from said user by:
a. providing software to the users that perform some useful functions to the user which could include managing a users financial account or accounts,
b. providing a means wherein the software from time to time or as designated by the software provider, download promotions for products or services and or solicitations and present these promotions or solicitations to the software user,
thereby creating a channel through which it can send promotions or solicitations to the software users.

2. A method for a company to use financial software to promote or advertise financial products or services to users of the software or solicit business from said user by:
a. providing financial or money management software to the users to be used by said users to manage their financial account or accounts,
b. providing a means wherein the software from time to time or as designated by the software provider, download promotions for products or services and or solicitations and present these promotions or solicitations to the software user,
thereby creating a channel through which it can send promotions or solicitations to the software users.

3. The method of claim 1 further include adding the capability of said software to be used by the user to manage various kinds of financial accounts, including investment accounts,

4. The method of claim 2 further include distribution the software by various means:
a. including by postal mail, downloading from a website or be picked up at locations designated by the software provider or an entity working on it's behalf,
b. in some implementation of this invention, the recipient of the software may be required to pay for the software, the preferred embodiment is to not charge the users for the software thereby increasing the likelihood that the number of users will be larger than if users had to pay for the software, thereby creating a larger user base that can be targeted with promotions or solicitations.

5. The method of claim 2 further include providing a means for the software to filter what promotions or solicitations it presents to the user by using the following steps:
a. the software analyzes the software user's accounts it is being used to manage,
b. the software analyzes the downloaded promotion or solicitation to determine if said promotion or solicitation should be offered to the software user, using various methodologies that are supplied through various means including being programmed into the software or included in the promotion or solicitation or obtained from other external and internal sources,
c. presented only those promotions or solicitations to the user which the software concludes to be of interest to the software user based on the methodologies it applied.
d. promotional presentations or solicitation men be modified to include but is not limited to information derived from the users account or accounts, generated data, or information obtained from other sources,
whereby users of the software are not bombarded by promotions or solicitations that are not relevant to them, but instead, receive promotions or solicitations that are tailored to the user thereby increasing the likelihood the user will view such promotions or solicitations as useful and is an added benefit to using the software,
whereby likelihood of the user concluding such promotions or solicitations are an unwanted, nuisance to be ignored is reduced or eliminated.

6. The software of claim 2 further includes customizing or private labeling the software interface to:
a. displaying the logo of the company that sends the promotions or provided the software,
b. changing the name of the software to a name that links the software its provider or entity that supplies the promotions or solicitations,
c. changing the color scheme of the software to one set by the entity that supplies the software, promotion or solicitations, allowing the software or promotions provider create a uniform look across other products they may have,
thereby causing the users of the software to view or think of the software as an extension of the software or promotion provider.

7. The methods of claim 2 further includes downloading promotions or solicitations in batches, some of which may never be displayed to the user, thereby protecting the user's privacy by preventing the promotions or solicitations provider from determining the types of accounts the user has by examining what the types of promotions or solicitations are being downloaded.

8. The method of claim 2 further include preventing the software from uploading any of the users personal or account information when downloading promotions or solicitations, to further protect the user's privacy.

9. The software of claim 2 further includes a means to extend or modify the functions of the software by:
a. creating modules containing new and or improved software functions consisting of screens,
b. code logic and menus, made from web pages and script code that needs no compiling,
c. providing a means wherein said software from time to time or if instructed by the user checks for the existence of modules that have not been downloaded and if such modules exist,
d. download and self deploy said modules,
thereby preventing the software distributor from having to release new compiled versions of said software each time a new functionality or feature is added, removed or modified in the software.

10. The software of claim 2 further includes a means wherein the Microsoft agent character software, a text to speech, and a speech to text software engines are used to:
a. allow the user to input instructions to the software by speaking such instructions to the software,
b. allow the software agent character to speak out promotion or other information to the user,
to create an even closer feeling of personalization in the software user mind to causing them to react positively to promotions and instructions.

11. The software of claim 2 further includes a means wherein the Microsoft agent character software, a text to speech, and speech to text software engines are used to:
a. allow the user to use voice commands to instruct the software to search the internet or local computer for products or services that the software user desires,
b. provide a means wherein the software displays the result by various means including speaking the search result information to the user.

12. The software of claim 11 wherein said products or services include all financial products and service including as well as all forms of investment and brokerage products and services.

13. The software of claim 2 further including providing a means wherein the user can instruct the software to search for products or services that the software user desires and for the software to display the results of the search to the user within the software thereby preventing the user from having to use additional software or web search engines to locate such information and reduce the possibility of the user being enticed by external products or services that the software provider knows nothing about.

14. The software of claim 2 further including providing a means wherein promotions are created and uploaded to a central repository, to be downloaded by the software , each promotion includes but are not limited to the following features:
a. a name and description of the promotion,
b. a promotion's start and end dates thereby allowing the release of promotions before their start date and the automatic termination of a promotion on the end date, macros representing various account information such as account names,
c. balances, interest rate, and various dates,
d. the software will replace these macros with the actual account information, thereby allowing the promotion creator to create customize promotions to the user,
e. a website or page address where additional information about the promotion can be obtained if the user is online, text containing information to be presented to the user if the user is viewing the promotion offline,
f. text to be presented to the user if the user request the software to present promotional offers it may have downloaded and the software deems the promotion information to not be applicable to the user,
g. a question the software will use to ask the user for authorization to go and search for promotions for the user,
h. a time period that must elapse before the software reevaluates a promotion that it previously evaluated and did not present to the user because it deemed the promotion as not being applicable to the user at the time of the evaluation,
i. a promotion or solicitation ID, to allow promotions and solicitation from multiple providers to be stored together and for the software to retrieve promotions or solicitations for a provider from the central repository by supplying said ID.

15. The software of claim 2 further include a means for the software to pre-populate or fill in as much information that may be required from the user when the user is taking advantage of a promotion or solicitation,
thereby reducing the change of the user not following though with the offer because of the amount of effort that may be needed to do so,
whereby the chance of the user providing incorrect information about the user's accounts to the promotion provider is reduced by the software filling in some or all the required information.

16. The software of claim 2 further include the capability of the software to allow the user to test various financial scenarios including the purchasing, selling, donation of assets or investments, and adding the capability for the software to recommend products or services from the software or promotions provider before, during or after the test scenarios are done,
thereby giving the software or promotions provider a significant advantage over other companies that provide similar products or services by offering its products or services to the user while the idea is still being developed by said user.

17. The method of claim 2 further include allowing the creation of promotions and solicitations that are targeted at any accounts the software user may be managing through the software that are held at other companies that is not associated with the software or promotions provider,
thereby giving the software or promotions provider an opportunity to influence the user to switch the account or accounts from the company where it is being held to a company the software or promotions provider recommends, whereby the software or promotions provider is now aware of accounts the it would not have normally known without the software.

18. The method of claim 3 further include providing a means for the software to filter what promotions or solicitations it presents to the user by using the following steps:
a. the software analyzes the software user's accounts it is being used to manage,
b. the software analyzes the downloaded promotion or solicitation to determine if said promotion or solicitation should be offered to the software user, using various methodologies that are supplied through various means including being programmed into the software or included in the promotion or solicitation or obtained from other external and internal sources,
c. presented only those promotions or solicitations to the user which the software concludes to be of interest to the software user based on the methodologies it applied.
d. promotional presentations or solicitation men be modified to include but is not limited to information derived from the users account or accounts, generated data, or information obtained from other sources,
whereby users of the software are not bombarded by promotions or solicitations that are not relevant to them, but instead, receive promotions or solicitations that are tailored to the user thereby increasing the likelihood the user will view such promotions or solicitations as useful and is an added benefit to using the software,
whereby likelihood of the user concluding such promotions or solicitations are an unwanted, nuisance to be ignored is reduced or eliminated.

19. The software of claim 18 further include a means for the software to pre-populate or fill in as much information that may be required from the user when the user is taking advantage of a promotion or solicitation,
thereby reducing the change of the user not following though with the offer because of the amount of effort that may be needed to do so,
whereby the chance of the user providing incorrect information about the user's accounts to the promotion provider is reduced by the software filling in some or all the required information.

20. The software of claim 19 further include the capability of the software to allow the user to test various financial scenarios including the purchasing, selling, donation of assets or investments, and adding the capability for the software to recommend products or services from the software or promotions provider before, during or after the test scenarios are done,
thereby giving the software or promotions provider a significant advantage over other companies that provide similar products or services by offering its products or services to the user while the idea is still being developed by said user.
